(19) United States
(12) Patent Application Publication
(10) Pub. No.: US 2026/0016686 A1
(43) Pub. Date: Jan. 15, 2026

(54) DISPLAY DEVICE

(71) Applicant: ASUSTeK COMPUTER INC., Taipei City (TW)

(72) Inventors: Wen-Chang Hung, Taipei City (TW); Ji-Ping Sheng, Taipei City (TW); Ting-Wei Huang, Taipei City (TW); Bo-Kai Zhang, Taipei City (TW)

(73) Assignee: ASUSTeK COMPUTER INC., Taipei City (TW)

(21) Appl. No.: 19/207,404

(22) Filed: May 14, 2025

(30) Foreign Application Priority Data
Jul. 10, 2024 (TW) 113125790

(51) Int. Cl. G02B 27/00; G02B 27/28; G02B 27/42

(52) U.S. Cl. CPC G02B 27/0037; G02B 27/283; G02B 27/286; G02B 27/4211

(57) ABSTRACT

A display device, including a display panel, a polarization light splitting element, a transflective element, a diffraction optical element, a quarter wave plate, and at least one lens. The display panel is used to provide an image beam. The polarization light splitting element, the transflective element, the diffraction optical element, the quarter wave plate, and the at least one lens are located on a transmission path of the image beam. The transflective element is located between the polarization light splitting element and the display panel. The diffractive optical element is located between the transflective element and the display panel. The quarter wave plate is located between the transflective element and the polarization light splitting element. The at least one lens is located between the diffractive optical element and the quarter wave plate.

### CROSS-REFERENCE TO RELATED APPLICATION

This application claims the priority benefit of Taiwan application serial no. 113125790, filed on Jul. 10, 2024. The entirety of the above-mentioned patent application is hereby incorporated by reference herein and made a part of this specification.

### BACKGROUND

### Technical Field

The disclosure relates to a display device.

### Description of Related Art

The major difference between the technical structure of folded optical paths and the previous two generations of technical structures of conventional aspheric and Fresnel lenses is that, compared to the previous two generations of technical structures, the total track length (TTL) of the optical system under the technical structure of folded optical paths is reduced by approximately 50% to 60%. However, the technical structure of folded optical paths adopts the characteristics of a light polarization state and achieves the effect of a folded optical path through the disposition of a half mirror (HM). 50% of the optical efficiency is lost each time the light passes through the half mirror. Thus, while the TTL is reduced for the technical structure of folded optical paths, an issue of low optical efficiency also occurs. In current technology, after an image beam provided by a display panel passes through the current technical structure of folded optical paths, the maximum theoretical value of the optical efficiency of the emitted image beam is about 25% of the original image beam.

In addition, in the current technical structure of folded optical paths, the light passing through the lenses of the optical system still suffers from optical aberrations such as spherical aberration, coma, astigmatism, and chromatic dispersion due to refraction at an interface. In the current technology, optical aberrations are minimized by increasing the number of lens surfaces. However, with the development of displays and the increase in resolution, the number of lenses also increases to meet the requirement of imaging with smaller pixels and to solve issues including optical and chromatic aberrations. This is also detrimental to the thinning of head mounted displays (HMD), makes optical design more challenging, and increases product cost.

### SUMMARY

The disclosure provides a display device, including a display panel, a polarization light splitting element, a transflective element, a diffraction optical element, a quarter wave plate, and at least one lens. The display panel is used to provide an image beam. The polarization light splitting element, the transflective element, the diffraction optical element, the quarter wave plate, and the at least one lens are located on a transmission path of the image beam. The transflective element is located between the polarization light splitting element and the display panel. The diffractive optical element is located between the transflective element and the display panel. The quarter wave plate is located between the transflective element and the polarization light splitting element. The at least one lens is located between the diffractive optical element and the quarter wave plate.

Based on the above, the display device of the disclosure reflects and reuses the image beam whose optical efficiency would originally be lost through the configuration of the diffraction optical element, thereby providing the display device with good optical efficiency. In addition, when the diffraction optical element is a cholesterol liquid crystal lens, the display device further utilizes the inverse chromatic dispersion characteristics of the diffraction optical element as a compensator for lens dispersion in the imaging system of the display device, thereby eliminating chromatic aberrations of the display device and further providing the display device with good imaging quality.

To make the features and advantages of the disclosure more comprehensible, several embodiments accompanied with drawings are described in detail as follows.

### BRIEF DESCRIPTION OF THE DRAWINGS

FIG. 1 is a schematic structural diagram of a display device in an embodiment of the disclosure.

FIGS. 2A and 2B are schematic structural diagrams of various diffraction optical elements in FIG. 1.

FIG. 3 is a schematic optical path diagram of the display device in FIG. 1.

FIGS. 4 to 7 are schematic structural diagrams of a display device in different embodiments of the disclosure.

### DESCRIPTION OF THE EMBODIMENTS

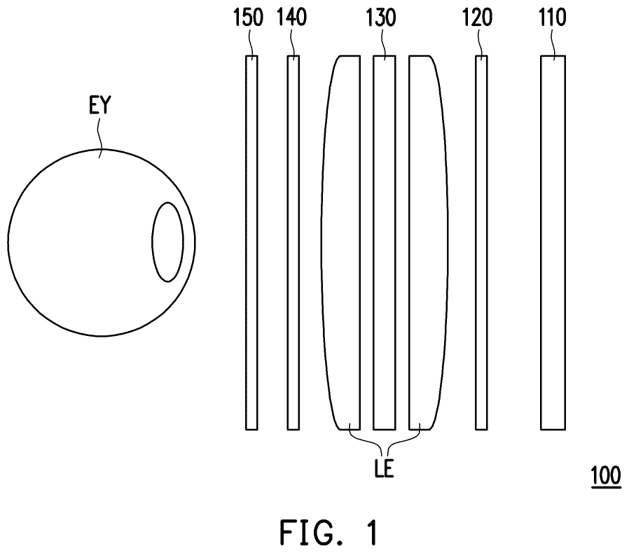

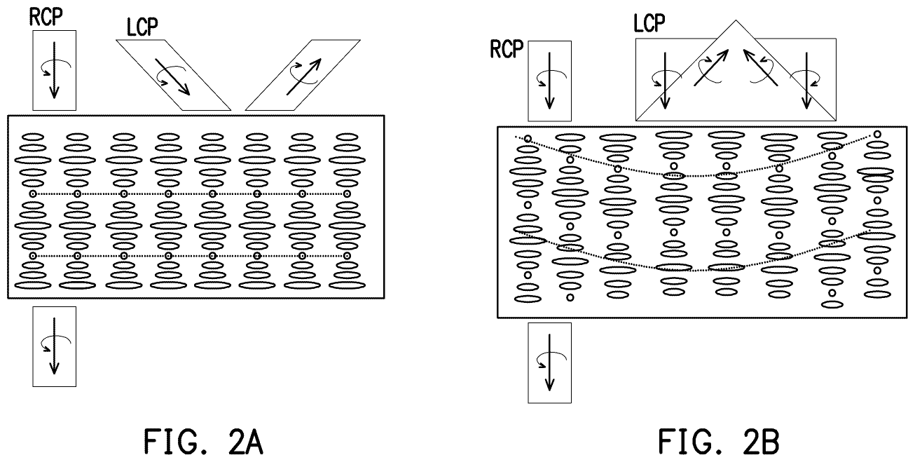

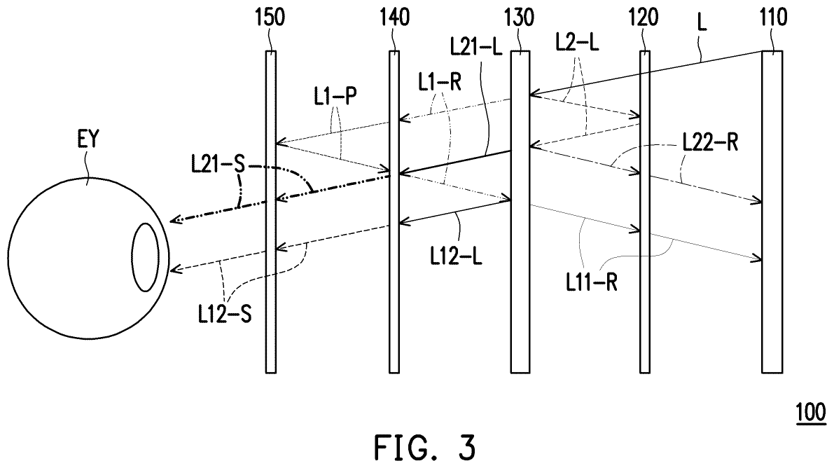

FIG. 1 is a schematic structural diagram of a display device in an embodiment of the disclosure. FIGS. 2A and 2B are schematic structural diagrams of various diffraction optical elements in FIG. 1. FIG. 3 is a schematic optical path diagram of the display device in FIG. 1. Referring to FIG. 1, a display device 100 in this embodiment includes a display panel 110, a diffraction optical element 120, a transflective element 130, a quarter wave plate 140, a polarization light splitting element 150, and at least one lens LE. The display panel 110 is, for example, a liquid crystal display panel or a micro organic light-emitting diode display panel in a size of 1 inch to 3 inches. The diffraction optical element 120 may be a cholesterol liquid crystal (CLC) reflector or a CLC lens. The transflective element 130 is a half mirror (HM), and the polarization light splitting element 150 is a reflection polarization (RP) film.

Specifically, as shown in FIGS. 1 and 3, in this embodiment, the display panel 110 is used to provide an image beam L. The display panel 110 may include an unshown combination of a polarization film and a quarter wave plate, so that a polarization state of the image beam L is a first circular polarization state when the image beam L is emitted from the display panel 110. In this embodiment, the first circular polarization state is a right-handed circular polarization state. However, the disclosure is not limited thereto. In another embodiment, the first circular polarization state may also be a left-handed circular polarization state.

On the other hand, as shown in FIGS. 1 and 3, in this embodiment, the diffraction optical element 120, the transflective element 130, the at least one lens LE, the quarter wave plate 140, and the polarization light splitting element 150 are located on a transmission path of the image beam L. Moreover, the transflective element 130 is located between the polarization light splitting element 150 and the display panel 110. The diffraction optical element 120 is located between the transflective element 130 and the display panel 110. The quarter wave plate 140 is located between the transflective element 130 and the polarization light splitting element 150. The at least one lens LE is located between the diffraction optical element 120 and the quarter wave plate 140. Furthermore, in this embodiment, the at least one lens LE includes a first lens LE1 and a second lens LE2. The transflective element 130 is located between the first lens LE1 and the second lens LE2. The second lens LE2 is located between the transflective element 130 and the display panel 110. The first lens LE1 is located between the transflective element 130 and the polarization light splitting element 150.

More specifically, as shown in FIGS. 2A and 2B, in this embodiment, the CLC reflector or CLC lens serving as the diffraction optical element 120 are arranged in a spiral manner on a two-dimensional plane through CLC molecules, thereby having selectivity for circular polarization light and can be used for designing a folded optical path of the image beam L. For example, the process of making a CLC lens involves mixing a certain concentration of chiral dopant, photo-initiator, and solvent into the CLC molecules to form a CLC solution and make a brilliant yellow (BY) dye that a photo-alignment layer (PAL) needed. Next, the brilliant yellow dye is spin-coated onto a clean glass or plastic substrate to form a thin film layer that is uniform in thickness. Moreover, a PAL is exposed for several minutes with linear polarization collimated laser beam at a wavelength of 457 nm to complete making the PAL. Next, the prepared CLC solution is spin-coated onto the PAL and cured using ultraviolet (UV) light. During the polymerization process, the CLC molecules form a spiral shape. This process may be repeated according to the needed thickness, finally resulting in the CLC reflector shown in FIG. 2A or the CLC lens shown in FIG. 2B.

Moreover, as shown in FIG. 2B, in this embodiment, the CLC lens incorporates a lens profile during a light interference process and thus includes phase information equivalent to the lens function. As a result, when light passes through the CLC lens shown in FIG. 2B, the CLC lens focuses the light having a specific polarization state. Moreover, when the diffraction optical element 120 is a CLC lens, a diffraction angle of the diffraction optical element 120 is proportional to a wavelength of the passing light beam. This means that the light with a red light wavelength passing through the diffraction optical element 120 will have a larger diffraction angle, that is, a shorter imaging distance compared to the light with a green wavelength and the light with a blue wavelength. This inverse dispersion characteristic is opposite to the dispersion characteristic of the lens LE and may be used to correct optical chromatic aberration.

For example, as shown in FIGS. 2A and 2B, in this embodiment, the CLC reflector or CLC lens serving as the diffraction optical element 120 is used to enable a light beam having a first circular polarization state to pass through and reflect a light beam having a second circular polarization state. For example, as shown in FIG. 2A, in this embodiment, the first circular polarization state is a right-handed circular polarization state, and the second circular polarization state is a left-handed circular polarization state, so that a right-handed circular polarization light passes through and a left-handed circular polarization light is reflected. However, the disclosure is not limited thereto. In another embodiment, when the first circular polarization state is the left-handed circular polarization state, the second circular polarization state is the right-handed circular polarization state.

Moreover, as shown in FIGS. 2A and 2B, when the diffraction optical element 120 is either the CLC reflector or the CLC lens, a light beam RCP having the first circular polarization state can pass through the diffraction optical element 120. Though a light beam LCP having the second circular polarization state can also be reflected by the diffraction optical element 120, the light beam LCP having the second circular polarization state is not focused when passing through the CLC reflector in FIG. 2A. Instead, the light beam LCP having the second circular polarization state is focused when passing through the CLC lens in FIG. 2B. This focusing behavior has inverse dispersion characteristics. This way, when the diffraction optical element 120 is the CLC lens, the light beam LCP having the second circular polarization state is focused with inverse dispersion characteristics. When the diffraction optical element 120 is used in conjunction with conventional optical lenses, an effect of eliminating the chromatic aberrations of conventional optical lenses is achieved.

On the other hand, specifically, a material of the transflective element 130 may be transparent plastic, glass, or film, with a special reflective coating on a surface, thereby enabling a part of an incident light to penetrate the transflective element 130 while reflecting another part of the incident light. In this embodiment, through the transflective element 130, a half of the incident light is formed as a transmitting light beam, and the other half of the incident light is formed as a reflecting light beam.

For example, in this embodiment, for a material of the at least one lens LE, transparent plastic or glass with a refractive index n of 1.4 to 1.8 and an Abbe number v of 20 to 80 may be selected. A curvature of the lens LE may be convex or concave, and a surface of the lens LE may be spherical, cylindrical, aspherical, or freeform. The material, curvature, and surface of the lens LE may be selected according to the designer's needs.

Moreover, in this embodiment, the quarter wave plate 140 is used as a phase retardation plate, so that the light beam having the first circular polarization state is formed as a light beam having a first linear polarization state after passing through the quarter wave plate 140, and the light beam having the second circular polarization state is formed as a light beam having a second linear polarization state after passing through the quarter wave plate 140. On the other hand, in this embodiment, the polarization light splitting element 150 includes a structure of a multilayer film or a grating. Thus, the polarization light splitting element 150 may be used to reflect the light beam having the first linear polarization state and allow the light beam having the second linear polarization state to pass through. For example, as shown in FIGS. 2A, 2B, and 3, in this embodiment, since the first circular polarization state is the right-handed circular polarization state, the first linear polarization state is a P polarization state. Since the second circular polarization state is the left-handed circular polarization state, the second linear polarization state is an S polarization state.

This way, as shown in FIG. 3, after the image beam L having the first circular polarization state is emitted from the display panel 110, the image beam L penetrates the diffraction optical element 120. When the image beam L penetrating the diffraction optical element 120 is transmitted to the transflective element 130, a part of the image beam L penetrates the transflective element 130 and forms an image beam L1-R having the first circular polarization state, and another part of the image beam L is reflected by the transflective element 130 and forms an image beam L2-L having the second circular polarization state. Next, the image beam L1-R penetrating the transflective element 130 and having the first circular polarization state forms a first image beam L1-P having the first linear polarization state after passing through the quarter wave plate 140. After the first image beam L1-P is reflected by the polarization light splitting element 150 and passes through the quarter wave plate 140 again, the image beam L1-R having the first circular polarization state is formed. Next, when the image beam L1-R penetrating the quarter wave plate 140 and having the first circular polarization state is transmitted to the transflective element 130, a part of the image beam L1-R penetrates the transflective element 130 and forms an image beam L11-R having the first circular polarization state, and another part of the image beam L is reflected by the transflective element 130 and forms an image beam L12-L having the second circular polarization state. The image beam L12-L being reflected by the transflective element 130 and having the second circular polarization state forms an image beam L12-S having the second linear polarization state after passing through the quarter wave plate 140, thereby penetrating the polarization light splitting element 150 and further forming an image on a human eye EY. At this time, since the image beam L12-S penetrating the polarization light splitting element 150 and forming an image on the human eye EY passes through the transflective element 130 twice, an optical efficiency of the image beam L12-S is 25% of that of the image beam L emitted from the display panel 110.

On the other hand, another part of the image beam L is reflected by the transflective element 130 and forms the image beam L2-L having the second circular polarization state. When the image beam L2-L is transmitted to the diffraction optical element 120, the image beam L2-L is reflected by the diffraction optical element 120 and transmitted to the transflective element 130. At this time, a part of the image beam L2-L penetrates the transflective element 130 and forms an image beam L21-L having the second circular polarization state, while another part of the image beam L is reflected by the transflective element 130 and forms an image beam L22-R having the first circular polarization state. Next, the image beam L21-L having the second circular polarization state formed by penetrating the transflective element 130 is transmitted to the quarter wave plate 140, and forms an image beam L21-S having the second linear polarization state after passing through the quarter wave plate 140, thereby penetrating the polarization light splitting element 150 and further forming an image on the human eye EY. At this time, since the image beam L21-S penetrating the polarization light splitting element 150 and forming an image on the human eye EY passes through the transflective element 130 twice, an optical efficiency of the image beam L21-S is 25% of that of the image beam L emitted from the display panel 110.

This way, a combined light quantity of the image beam L21-S and the image beam L12-S emitted from the display device 100 and forming images on the human eye EY is about 50% of the original image beam L emitted from the display panel 110. Thus, the display device 100 realizes an optical efficiency of about 50%, which is higher than the optical efficiency of 25% of current display devices with folded optical path structures.

This way, through the configuration of the diffraction optical element 120, a response can be generated to a specific polarization according to different arrangements of CLC molecules, thereby reflecting and reusing the image beam L2-L whose optical efficiency would originally be lost, further providing the display device 100 with good optical efficiency. In addition, when the diffraction optical element 120 is a CLC lens, a diffraction angle of the diffraction optical element 120 is proportional to a wavelength of the passing light beam. This means that the light with a red light wavelength passing through the diffraction optical element 120 will have a larger diffraction angle, that is, a shorter imaging distance compared to the light with a green wavelength and the light with a blue wavelength. This inverse dispersion characteristic is opposite to the dispersion characteristic of the lens LE. Thus, when the diffraction optical element 120 is the CLC lens, the diffraction optical element 120 may serve as a compensator for the dispersion of the at least one lens LE by adjusting the thickness of the diffraction optical element 120, thereby eliminating the chromatic aberration of the display device 100, further providing the display device 100 with good imaging quality.

In addition, as shown in FIG. 1, in this embodiment, a distance between the polarization light splitting element 150 and the transflective element 130 is a first distance, and a distance between the diffraction optical element 120 and the transflective element 130 is a second distance. The first distance is equal to the second distance, and an optical surface of the first lens LE1 and an optical surface of the second lens LE2 are mirror-symmetrical relative to the transflective element 130. This way, due to the design of symmetrical optical paths, the optical path lengths of the image beams L21-S and L12-S are approximately the same, thereby reducing ghost images.

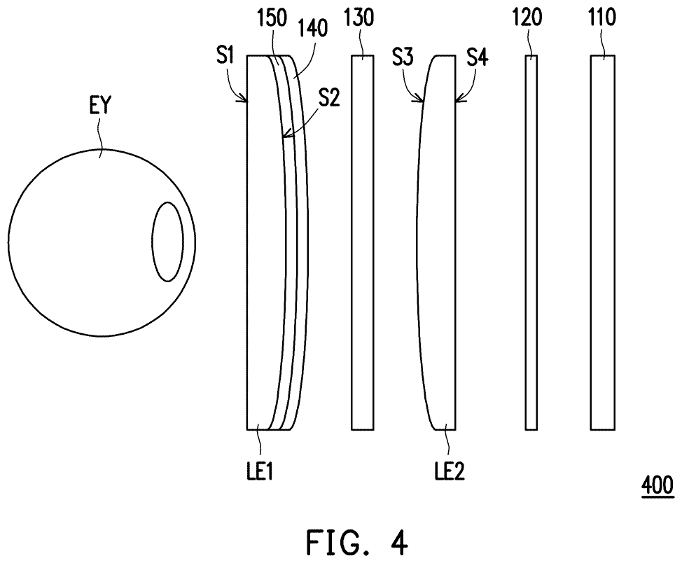

Furthermore, in the previous embodiments, the quarter wave plate 140 and the polarization light splitting element 150 are exemplarily shown as optical elements disposed independently, but the disclosure is not limited thereto. In other embodiments, the quarter wave plate 140 and the polarization light splitting element 150 may also be thin film layers disposed on the lens LE, thereby realizing the design of folded optical paths and further providing the display device with the aforementioned effects and advantages. Further descriptions will be provided with reference to FIGS. 4 to 7.

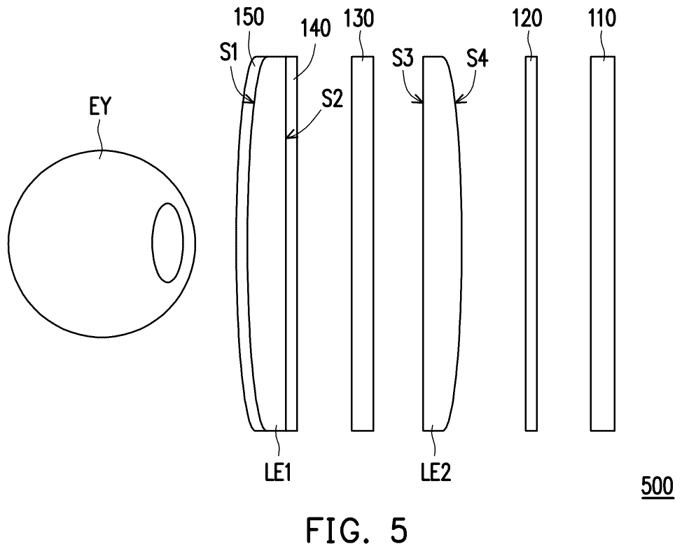

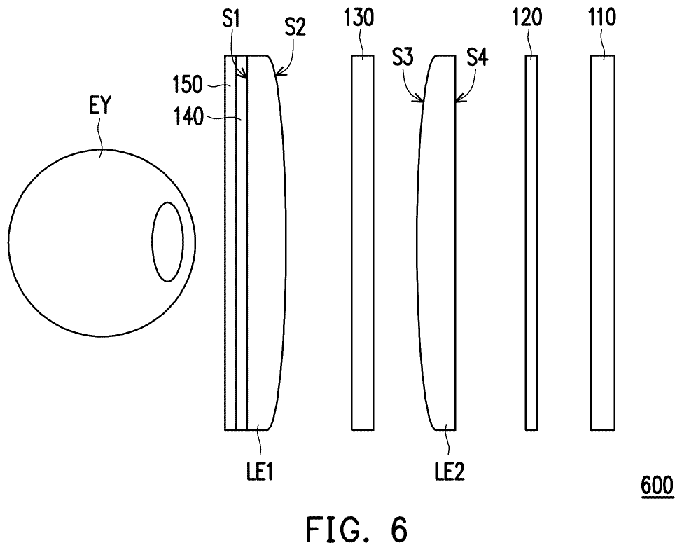

FIGS. 4 to 7 are schematic structural diagrams of a display device in different embodiments of the disclosure. Please refer to FIGS. 4 to 6. Display devices 400, 500, and 600 in the embodiments of FIGS. 4 to 6 are similar to the display device 100 in FIG. 1, with differences described as follows. In the embodiment of FIG. 4, the first lens LE1 of the display device 400 has a first surface S1 and a second surface S2 opposite to each other. The first surface S1 is away from the display panel 110, and the second surface S2 faces the display panel 110. The second lens LE2 has a third surface S3 and a fourth surface S4 opposite to each other. The third surface S3 is away from the display panel 110, and the fourth surface S4 faces the display panel 110. The quarter wave plate 140 and the polarization light splitting element 150 are thin film layers located on the second surface S2 of the first lens LE1. In the embodiment of FIG. 5, the quarter wave plate 140 of the display device 500 is a thin film layer located on the second surface S2 of the first lens LE1, and the polarization light splitting element 150 of the display device 500 is a thin film layer located on the first surface S1 of the first lens LE1. In the embodiment of FIG. 6, the quarter wave plate 140 and the polarization light splitting element 150 of the display device 600 are thin film layers located on the first surface S1 of the first lens LE1.

However, as shown in FIGS. 4 to 6, the quarter wave plate 140 of each of the display devices 400, 500, and 600 is still located between the transflective element 130 and the polarization light splitting element 150. Thus, optical paths the same as the folded optical path of the display device 100 in FIG. 3 can still be realized for the display devices 400, 500, and 600 through the configuration of the diffraction optical element 120. Moreover, when the diffraction optical element 120 is the CLC lens, the chromatic aberrations of the display devices 400, 500, and 600 may be eliminated through the inverse dispersion characteristics, thereby providing the display devices 400, 500, and 600 with good optical efficiency and imaging quality, further achieving similar effects and advantages as the display device 100, which will not be repeated here.

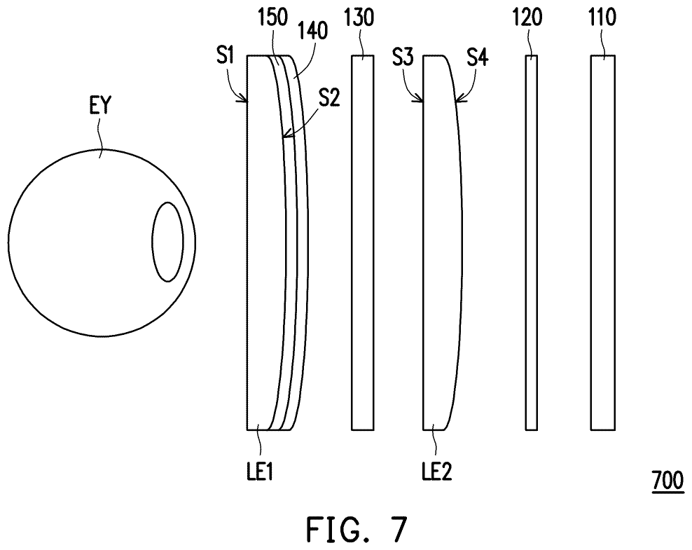

On the other hand, in the embodiment of FIG. 7, a display device 700 is similar to the display device 400 in FIG. 4. The one difference is that the optical surface of the first lens LE1 and the optical surface of the second lens LE2 of the display device 700 in FIG. 7 may form a non-mirror-symmetrical structure relative to the transflective element 130 according to the actual imaging needs. However, in the embodiment of FIG. 7, the quarter wave plate 140 of the display device 700 is still located between the transflective element 130 and the polarization light splitting element 150. Thus, an optical path the same as the folded optical path of the display device 100 in FIG. 3 can still be realized for the display device 700 through the configuration of the diffraction optical element 120. Moreover, when the diffraction optical element 120 is the CLC lens, the chromatic aberration of the display device 700 may be eliminated through the inverse dispersion characteristics, thereby providing the display device 700 with good optical efficiency and imaging quality, further achieving similar effects and advantages as the display device 100, which will not be repeated here.

In addition, the optical surface of the first lens LE1 and the optical surface of the second lens LE2 of each of the display devices 500 and 600 in FIGS. 5 and 6 may also form a non-mirror-symmetrical structure similar to that of the display device 700 in FIG. 7 relative to the transflective element 130 according to the actual imaging needs. Thus, the display device formed can also have good optical efficiency and imaging quality, further achieving similar effects and advantages as the display device 100, which will not be repeated here.

In summary, the display device of the disclosure reflects and reuses the image beam whose optical efficiency would originally be lost through the configuration of the diffraction optical element, thereby providing the display device with good optical efficiency. In addition, when the diffraction optical element is a cholesterol liquid crystal lens, the display device further utilizes the inverse chromatic dispersion characteristics of the diffraction optical element as a compensator for lens dispersion in the imaging system of the display device, thereby eliminating chromatic aberrations of the display device and further providing the display device with good imaging quality.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A display device, comprising:
a display panel, used to provide an image beam;
a polarization light splitting element, located on a transmission path of the image beam;
a transflective element, located on the transmission path of the image beam and between the polarization light splitting element and the display panel;
a diffraction optical element, located on the transmission path of the image beam and between the transflective element and the display panel;
a quarter wave plate, located on the transmission path of the image beam and between the transflective element and the polarization light splitting element; and
at least one lens, located on the transmission path of the image beam and between the diffraction optical element and the quarter wave plate.

2. The display device according to claim 1, wherein a distance between the polarization light splitting element and the transflective element is a first distance, and a distance between the diffraction optical element and the transflective element is a second distance, the first distance being equal to the second distance.

3. The display device according to claim 1, wherein the at least one lens comprises a first lens and a second lens, the transflective element being located between the first lens and the second lens, wherein the second lens is located between the transflective element and the display panel, and the first lens is located between the transflective element and the polarization light splitting element.

4. The display device according to claim 3, wherein an optical surface of the first lens and an optical surface of the second lens are mirror-symmetrical relative to the transflective element.

5. The display device according to claim 3, wherein the first lens has a first surface and a second surface opposite to each other, the first surface being away from the display panel, the second surface facing the display panel, wherein each of the quarter wave plate and the polarization light splitting element is a film layer located on the second surface.

6. The display device according to claim 3, wherein the first lens has a first surface and a second surface opposite to each other, the first surface being away from the display panel, the second surface facing the display panel, wherein the quarter wave plate is a film layer located on the second surface, and the polarization light splitting element is a film layer located on the first surface.

7. The display device according to claim 3, wherein the first lens has a first surface and a second surface opposite to each other, the first surface being away from the display panel, the second surface facing the display panel, wherein each of the quarter wave plate and the polarization light splitting element is a film layer located on the first surface.

8. The display device according to claim 1, wherein the diffraction optical element is a cholesterol liquid crystal lens, and the diffraction optical element is used to allow the image beam having a first circular polarization state to pass through and to reflect the image beam having a second circular polarization state.

9. The display device according to claim 8, wherein when the image beam having the first circular polarization state is transmitted to the transflective element, a part of the image beam penetrates the transflective element and forms a first image beam having the first circular polarization state, and another part of the image beam is reflected by the transflective element and forms a second image beam having the second circular polarization state, wherein when the image beam having the second circular polarization state is transmitted to the transflective element, a part of the image beam penetrates the transflective element and forms a third image beam having the second circular polarization state, and another part of the image beam is reflected by the transflective element and forms a fourth image beam having the first circular polarization state.

10. The display device according to claim 8, wherein the image beam with the first circular polarization state forms an image beam with a first linear polarization state after passing through the quarter wave plate, and the image beam with the second circular polarization state forms an image beam with a second linear polarization state after passing through the quarter wave plate.

11. The display device according to claim 8, wherein the polarization light splitting element is used to reflect the image beam having a first linear polarization state and to allow the image beam having a second linear polarization state to pass through.

12. The display device according to claim 8, wherein when the image beam is emitted from the display panel, a polarization state of the image beam is the first circular polarization state.
